(19) United States
(12) Patent Application Publication
(10) Pub. No.: US 2019/0029077 A1
(43) Pub. Date: Jan. 24, 2019

(54) Heated Mat

(71) Applicant: Wrap-On Company, LLC, Alsip, IL (US)

(72) Inventors: Phillip A. Surma, Alsip, IL (US); Cesar Ramirez, Alsip, IL (US)

(21) Appl. No.: 16/041,043

(22) Filed: Jul. 20, 2018

Related U.S. Application Data
(60) Provisional application No. 62/536,251, filed on Jul. 24, 2017.

(51) Int. Cl. H05B 3/34

(52) U.S. Cl. CPC H05B 3/34

(57) ABSTRACT

A heated mat adapted to be placed on a floor for supporting a chair and a user. The mat includes a generally sheet-like body with an elongate heating cable embedded within the body such that the mat will provide radiant heat to the user.

### RELATED APPLICATIONS

This application claims the benefit of U.S. Provisional Application No. 62/536,251, filed Jul. 24, 2017.

### BACKGROUND

The present disclosure is directed to a heated mat adapted to be placed on a floor for supporting a chair and a user, and in particular to a heated mat including a generally sheet-like body with an elongate heating cable embedded within the body such that the mat will provide radiant heat to the user sitting in the chair or standing on the mat.

### BRIEF DESCRIPTION OF THE DRAWING FIGURES

FIG. 1 is top plan view of an embodiment of the heated mat; and

FIG. 2 is a cross sectional view taken along line 2-2 of FIG. 1.

### DETAILED DESCRIPTION

The present disclosure relates to a heated mat 10 that is adapted to be placed on and supported by a floor and that is adapted to support a chair with a user sitting in the chair or a user standing on the mat 10.

Mat 10 includes a generally sheet-like body 12 having a generally planar bottom surface 14 and a generally planar top surface 16 that is spaced apart from and generally parallel to bottom surface 14. Mat 10 and body 12 have a thickness between bottom surface 14 and top surface 16 of approximately one-quarter inch (0.25″). Body 12 includes a peripheral edge 18 that extends around the perimeter of body 12. Peripheral edge 18 of mat 10 includes a front edge 20, a rear edge 22, a first side edge 24 and a second side edge 26, each of which may be generally linear. Body 12 may, when viewed in plan, be generally rectangular or square, and may include rounded or curved corners. Peripheral edge 18 of body 12 may be beveled to provide a smooth transition between a top surface of the floor adjacent body 12 and top surface 16 of body 12. Bottom surface 14 of body 12 is adapted to be placed on and supported by the top surface of an underlying floor. The floor may comprise carpeting, tile, wood, concrete and other types of flooring.

Body 12 includes a generally sheet-like bottom layer 30 that may be made from a plastic material, such as for example a polyvinyl chloride extrusion compound such as plastisol. Bottom layer 30 includes a generally planar bottom surface 32 that is generally coextensive with and that forms bottom surface 14 of body 12. Bottom layer 30 also includes a generally planar top surface 34 that is spaced apart from and generally parallel to bottom surface 32. Bottom layer 30 includes a peripheral edge 36 that extends around the perimeter of bottom layer 30 and that forms peripheral edges of bottom surface 32 and top surface 34. Peripheral edge 36 extends around the perimeter of bottom layer 30 coextensively with and forms a portion of peripheral edge 18 of body 12.

Body 12 also includes a generally sheet-like top layer 40 that may be formed from a plastic material, such as for example a polyvinyl chloride extrusion compound such as plastisol. Top layer 40 includes a generally planar bottom surface 42 and a generally planar top surface 44 that is spaced apart from and generally parallel to bottom surface 42. Bottom surface 42 of top layer 40 is joined or molded to top surface 34 of bottom layer 30. Top surface 44 of top layer 40 extends generally coextensively with and forms top surface 16 of body 12. Top layer 40 includes a peripheral edge 46 that extends around the perimeter of top layer 40 and that forms peripheral edges of bottom surface 42 and top surface 44. Peripheral edge 46 extends around the perimeter of body 12 coextensively with and forms a portion of peripheral edge 18 of body 12. Bottom layer 30 and top layer 40 are made from a plastic material that is strong, tough and durable, such that bottom layer 30 and top layer 40 are capable of supporting a chair and a user seated in the chair, including the concentrated point loads applied to top layer 40 by the feet or casters of the chair.

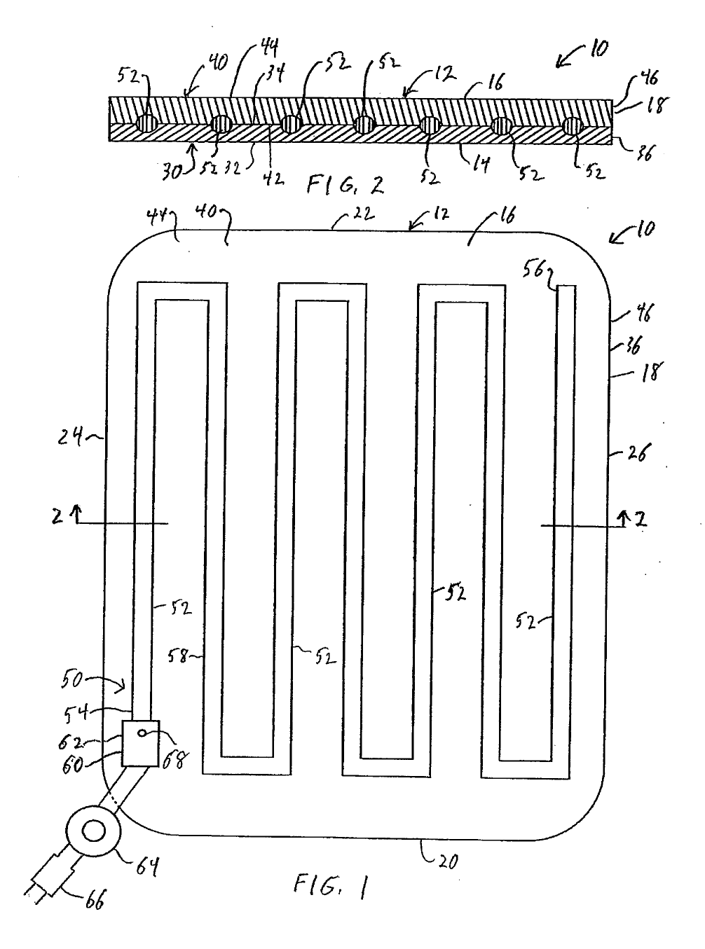

Heated mat 10 also includes a heating system 50. Heating system 50 includes an electrical heating cable 52. Heating cable 52 is elongate and flexible and extends between a first end 54 and second end 56. Heating cable 52 is embedded within body 12 between bottom layer 30 and top layer 40, and between bottom surface 14 and top surface 16 of mat 10. Heating cable 52 includes an electrical resistance element, such as a wire, that extends between first end 54 and second end 56 in a generally U-shaped manner such that the electrical resistance element includes two elongate, spaced apart and parallel lead wires that also extend between first end 54 and second end 56 and that are in electrical communication with one another. The electrical resistance element, and the lead wires thereof, are substantially enclosed within a sheath 58 of heating cable 52. Sheath 58 made be made from a heat conducting material that is also an electrical insulator, such as for example polyvinyl chloride (PVC). Heating cable 52 may extend within body 12 in a generally zig-zag or serpentine configuration as shown in FIG. 1, such that heating cable 52 extends between front edge 20 and rear edge 22 of mat 10, and between first side edge 24 and second side edge 26 of mat 10, to substantially cover the entire length and width of mat 10.

First end 54 of heating cable 52 is electrically coupled to a thermostat 60 and a timer 62 of heating system 50. Thermostat 60 and timer 62 electrically couple heating cable 52 to a switch 64 of heating system 50, such as a foot-activated switch. Switch 64 is adapted to selectively electrically couple thermostat 60, timer 62 and heating cable 52 to an electrical connector plug 66. Switch 64 and plug 66 are located externally outside of body 12 of mat 10. Plug 66 is adapted to be selectively coupled to a source of electrical power, such as by connection to a conventional 120 Volt electrical wall outlet. Heating system 50 also includes an indicator light 68, such as a light emitting diode (LED). Indicator light 68 is activated when the heating system 50 is turned on, and is deactivated when the heating system 50 is turned off by switch 64.

In operation, mat 10 is placed on the surface of a floor, such as in front of a desk, and plug 66 is electrically connected to a source of electrical power such as an electrical wall outlet. Switch 64 is selectively activated, either manually with the hand of a user or by pressing on switch 64 with the foot of a user, to thereby electrically energize heating system 50. Thermostat 60 selectively controls the electrical energization of the electrical resistance element of heating cable 52, such that when the electrical resistance element of heating cable 52 is energized by thermostat 60, heating cable 52 generates heat that is transferred by sheath 58 of heating cable 52 to body 12 of mat 10 and to top surface 16 of mat 10. Body 12 of mat 10 and top surface 16 of mat 10 radiate heat outwardly to warm an individual user sitting in a chair that is supported by the mat 10, or to a user who is standing on the mat 10. Thermostat 60 selectively controls the energization of heating cable 52, selectively supplying electrical power or stopping the supply of electrical power to heating cable 52, to control the amount of heat generated by heating cable 52 and to prevent heating cable 52 from overheating body 12 of mat 10 above a selected temperature, such as 110 degrees Fahrenheit (° F.). When heating system 50 is activated or turned on, indicator light 68 is activated to provide a visual indication that heating system 50 is activated. The user may selectively turn off or deactivate heating system 50 by pressing switch 64, either manually or by foot operation. Timer 62 automatically deactivates heating system 50 after a selected period of time, such as for example ten hours, in case the user forgets to turn off heating system 50 with switch 64.

Heating system 50 may be coupled to a standard 120 Volt electrical outlet. Heating system 50 uses only approximately 300 watts of power which is substantially less than the wattage used by typical space heaters. Mat 10 evenly distributes radiant heat and warmth from substantially the entire top surface 16 of mat 10 to a user of mat 10, and does not focus the distribution of heat to a particular spot as does a space heater. Mat 10 serves as floor mat or chair mat for the support of a chair and a person occupying the chair and for supporting a person standing on mat 10, as well as a radiant heater for warming the person using the mat 10. The mat 10 may thereby be used in place of space heaters that have a large power consumption, that provide only a focused distribution of heat, that take up valuable space, and that operate at high temperatures that can reach up to 200° F.

What is claimed is:

1. A mat adapted to be placed on a floor for providing heat to a user, the mat comprising:
a bottom sheet having a generally planar bottom surface adapted to be placed on the floor, a top surface, and a peripheral edge;
a top sheet having a bottom surface, a top surface and a peripheral edge, the bottom surface of the top sheet being joined to the top surface of the bottom sheet, the top surface of the top sheet adapted to support the user; and
a heating system including an elongate heating cable extending between a first end and a second end, the heating cable being embedded between the bottom sheet and the top sheet, the heating cable adapted to generate heat.

2. The mat of claim 1, wherein the bottom sheet comprises a layer of plastic material, and the top sheet comprises a layer of plastic material, the top sheet being molded to the bottom sheet.

3. The mat of claim 1, wherein the plastic material of the bottom sheet and of the top sheet comprises a polyvinyl extrusion compound.

4. The mat of claim 1, wherein the heating cable includes an electrical resistance element that extends between the first end and the second end of the heating cable in a generally U-shaped manner.

5. The mat of claim 4, wherein the electrical resistance element includes a first lead wire and a second lead wire that extends generally parallel to the first lead wire, the second lead wire being electrically connected to the first lead wire.

6. The mat of claim 4, wherein the electrical resistance element is enclosed within a sheath.

7. The mat of claim 6, wherein the sheath comprises polyvinyl chloride.

8. The mat of claim 1, wherein the heating cable extends across a length and a width of the top sheet in a generally serpentine manner.

9. The mat of claim 1, wherein the heating system includes a thermostat coupled to the heating cable, the thermostat adapted to selectively control the amount of heat generated by the heating cable.

10. The mat of claim 9, including a switch coupled to the heating cable, the switch adapted to selectively activate the heating system.

11. The mat of claim 10, including an indicator light adapted to provide a visual indication of when the heating system is activated by the switch.

12. The mat of claim 10, wherein the switch is operable by foot.

13. The mat of claim 9, wherein the heating system includes a timer adapted to deactivate the heating system after a selected period of time.

14. The mat of claim 9, wherein the thermostat is adapted to prevent the heating system from heating the mat to a temperature above about 110 degrees Fahrenheit.
